(19) United States
(12) Patent Application Publication
(10) Pub. No.: US 2004/0086737 A1
(43) Pub. Date: May 6, 2004

(54) Product packaging with improved printed paper and method of making the same

(76) Inventor: A. James Yockey, Cincinnati, OH (US)

Correspondence Address: DAVID M. LAFKAS, 7811 LAUREL AVENUE, CINCINNATI, OH, 45243, US

(21) Appl. No.: 10/286,495

(22) Filed: Nov. 1, 2002

(51) Int. Cl. B32B 27/00

(52) U.S. Cl. 428/507; 428/511

(57) ABSTRACT

The present invention relates to a skin film packaging pack having a paper substrate with a thickness from about 0.018 to about 0.032 inches and a porosity of about 22 to about 28 seconds, coated on a front side with a clay coating, and a covering film comprising an ionomer resin overlaying the front side of the paper substrate. The present invention further relates to a process of producing a skin film packaging pack in which one or more products are positioned on a front side of a backing support having a thickness from about 0.018 to about 0.032 inches and a porosity of about 22 to about 28 seconds, coated on the front side with a clay coating, and adhering a covering film to a front side of a backing support.

### BACKGROUND OF THE INVENTION

1. Field of the Invention

The invention relates to packaging of goods, in particular to packaging with a synthetic skin film over a paper support, wherein the paper support has improved printing properties.

2. Discussion of the Prior Art

Two primary conventional means of packaging goods wherein at least one side of a packaging support has a transparent cover film are known as “skin films” and “blister” packaging. Both the skin films and the blister packaging typically include a backing substrate made of a rigid support material. A product to be sold is placed on one side of the rigid material that is then enclosed by a transparent covering.

Skin film packaging encloses a product with a thin, flexible, transparent film that is typically heat sealed to the underlying backing substrate and product such that the transparent film takes the shape of the backing substrate and product.

In contrast, blister packages are commonly produced by adhering a rigid, preformed plastic blister or product holding capsule to the underlying backing substrate with the product confined between. The plastic blister is generally formed of clear, moldable material such as polyvinyl chloride (PVC). In order to adhere the plastic blister to the backing substrate, an adhesive coating must be applied to the surface of the backing substrate where the plastic blister is to be attached.

Examples of conventional blister packages are set forth in U.S. Pat. No. 6,010,784 to Peterson, U.S. Pat. No. 6,006,913 to Lüdenmann et al., and U.S. Pat. No. 5,542,235 to Konstandin, all of which are incorporated herein in their entirety by reference.

Skin film packaging tends to be more cost effective than the blister packaging process, because blister packaging requires addition manufacturing steps associated with pre-forming a molded plastic blister before the product can be sealed to the substrate backing. In skin film packaging, a continuous sheet of skin film is heated, sealed and self-molded to the shape of the backing substrate and one or more products at the time of packaging without any pre-fabrication molding.

Further, skin film packaging may have less bulk than blister packaging, which saves space in storage and sales capacities. The reduced bulk of skin film packaging also is more environmentally friendly in that the packaging, in a post-consumer stage, takes up less space as garbage than the bulkier blister packaging. Skin film packaging does not require the expensive tolling for plastic molds and sets up more rapidly than blister packaging.

Typically, skin films are sealed over most of, if not all, one side of the backing substrate. Although the skin films may be clear and transparent, covering the entire side of the backing substrate can dull, “washout” and/or distort the colors, graphics and text printed on the backing substrate when viewed through the adhered skin film.

Blister packaging typically does not necessitate or include adhering the plastic blister over most or all of the backing substrate. Thus, the printed material on the backing substrate of the blister packaging tends not to suffer a distortion because it is not covered by an adhesive and synthetic covering such as a skin film and/or blister package.

Thus, a packaging means is desired that possesses the economical, environmental and space advantages of skin film coating with the superior printed backing substrate properties of blister packaging.

### SUMMARY OF THE INVENTION

Various exemplary embodiments of the present invention include a skin film packaging pack comprising a paper substrate having a thickness from about 0.018 to about 0.032 inches and a porosity of about 22 to about 28 seconds. The paper substrate is coated on a front side with a clay coating, and then sealed with a covering film comprising an ionomer resin.

The various exemplary embodiments of the present invention further includes a process of producing a skin film packaging pack comprising positioning one or more products on a front side of a backing support, wherein the backing support has a thickness from about 0.018 to about 0.032 inches and a porosity of about 22 to about 28 seconds. The backing support is coated on the front side with a clay coating, and then sealed with a covering film to a front side of the backing support.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a schematic illustration of skin film packaging according to the various exemplary embodiments of the present invention.

FIG. 2 is a schematic illustration of blister packaging.

### DETAILED DESCRIPTION OF THE INVENTION

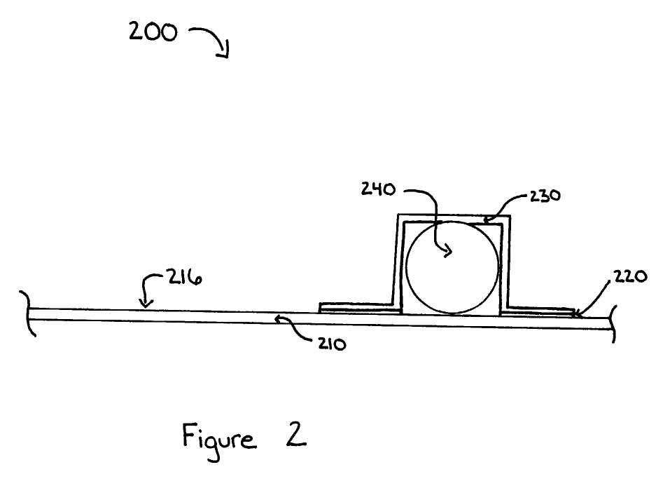

FIG. 2 illustrates a conventional blister package 200 in which a product 240 is enclosed by a plastic blister 230 and a backing substrate 210. The plastic blister 230 and backing substrate 210 are adhered together by an adhesive 220. As illustrated in FIG. 2, the plastic blister 230 may or may not encase and/or cover the entire backing substrate 210. Thus, the appearance of material printed on the backing substrate at, for example, a region 216 is not visually altered and/or distorted by the adhesive 220 and/or the plastic blister 240 because neither the adhesive 220 nor the plastic blister 240 are in contact with the region 216 of the backing substrate 210.

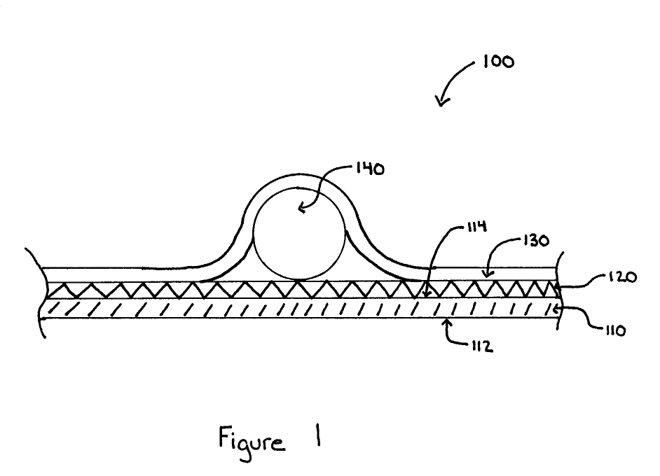

FIG. 1 illustrates a packaging means according the various exemplary embodiments of the present invention in which a product 140 is enveloped by a synthetic skin coat 130 and a backing support 110. The skin coat 130 and backing support 110 may be sealed together with an adhesive 120.

The backing support of the various exemplary embodiments of the present invention is a paper having a thickness of about 0.018 to about 0.032 inches. Preferably, the paper thickness is of about 0.022 inches to about 0.026 inches.

The paper of the exemplary embodiments of the present invention is clay coated. In the art, a paper web or sheet that is clay coated on one side is characterized as C1S. Paper that is clay coated on both sides is characterized as being C2S. The clay coating of the various exemplary embodiments of the present invention is preferably only on one side of the paper. Preferably, the one side of the paper is a front side 114 of the paper onto which material is printed and which side of the paper is in contact with the product sealed by the skin film 130. The backside 112 of the paper may also contain printed material, and may or may not be clay coated.

The composition of such coating is a fluidized blend of minerals such as coating clay, calcium carbonate, and/or titanium dioxide with starch and/or adhesive that is smoothly applied to a traveling web of the paper.

In the various exemplary embodiments of the present invention, the paper backing support has a porosity of about 22 to about 28 seconds. The porosity property defines the measurement of time that it takes for air to be pulled and/or drawn through the sheet of paper.

The paper substrate of the various exemplary embodiments of the present invention comprises a measured gloss value of about 30 to about 40 and a smoothness value of about 60 to about 75.

Any conventional ink may be introduced to the paper of the various exemplary embodiments of the present invention to produce any desired decorative colored pattern, text and/or graphics such as a product name, logo, picture, instructions and/or the like.

After all of the colored inks have been applied to the paper, an adhesive may be applied to the front side 114 of the paper of the various exemplary embodiments of the present invention. Such adhesive is preferably an ethylene vinyl acetate (EVA) based hot melt that is preferably clear and transparent when dry.

The one or more products to be packaged by the various exemplary embodiments of the present invention may have any shape and/or size provided that it comprises a smaller surface area than the backing support to which it is to be sealed by the skin coat. Examples of products include machine parts and equipment, crafts, office supplies, cosmetics, plumbing parts, after-market automotive parts, housewares, and the like. Such product or products are placed on the front side of the backing support. If adhesive is applied to the front side of the backing support, the product is placed on the front side of the backing support after the adhesive is applied.

Once the one or more products are positioned on the backing support, the skin film is applied to cover the backing support and the one or more products as a single continuous sheet. The skin film adheres to the backing support by the adhesive and/or by heat-sealing the film to the backing support.

The skin film of the various exemplary embodiments of the present invention is a thin, synthetic film. Preferably, the skin film is clear and transparent and comprised of ethylene acid copolymers. Most preferably the skin film is SURLYN®, manufactured by the DuPont Company.

The inventor of the various exemplary embodiments of the present invention surprisingly found that the above-described paper being clay coated on a single side and having a porosity of about 22 to about 28 seconds being heat sealed with a skin film of ethylene acid copolymers produces visually crisper, more detailed printed images as viewed through the skin film in contrast to printed conventional backing supports as viewed through the same skin films. The images of the various exemplary embodiments of the present invention are more visually attractive and are not dulled or washed-out as in skin film packaging with conventional components, and thus are more economically attractive while being more economically and environmentally friendly than blister packages.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A skin film packaging pack comprising:
a paper substrate having a thickness from about 0.018 to about 0.032 inches and a porosity of about 22 to about 28 seconds, coated on a front side with a clay coating;
a covering film comprising an ionomer resin overlaying the front side of the paper substrate.

2. The skin film packaging pack of claim 1, wherein the paper substrate has a gloss value of about 30 to about 40 and a smoothness value of about 60 to about 75.

3. The skin film packaging pack of claim 1, wherein the clay coating is selected from the group consisting of coating clay, calcium carbonate, titanium dioxide, and mixtures thereof.

4. The skin film packaging pack of claim 1, wherein the paper substrate comprises printed material at least on the front side.

5. The skin film packaging pack of claim 1, further comprising an adhesive on the front side of the paper substrate.

6. The skin film packaging pack of claim 5, wherein the adhesive is ethylene vinyl acetate.

7. The skin film packaging pack of claim 1, wherein the covering film is comprised of ethylene acid copolymers.

8. The skin film packaging pack of claim 7, wherein the covering film is a single continuous, clear, transparent film.

9. The skin film packaging pack of claim 1, further comprising one or more products, wherein the one or more products is between the front side of the paper substrate and the covering film.

10. A method of skin film packaging comprising:
positioning one or more products on a front side of a backing support, wherein the backing support has a thickness from about 0.018 to about 0.032 inches and a porosity of about 22 to about 28 seconds, coated on the front side with a clay coating; and
adhering a covering film to a front side of a backing support.

11. The method according to claim 10, wherein the paper substrate has a gloss value of about 30 to about 40 and a smoothness value of about 60 to about 75.

12. The method according to claim 10, wherein the clay coating is selected from the group consisting of coating clay, calcium carbonate, titanium dioxide, and mixtures thereof.

13. The method according to claim 10, wherein the paper substrate comprises printed material at least on the front side.

14. The method according to claim 10, wherein adhering the covering film to a front side of a backing support comprises introducing an adhesive between the front side of the paper substrate and the covering film.

15. The method according to claim 14, wherein the adhesive is ethylene vinyl acetate.

16. The method according to claim 10, wherein adhering the covering film to a front side of a backing support comprises heat sealing the front side of the paper substrate to the covering film.

17. The method according to claim 10, wherein the covering film is comprised of ethylene acid copolymers.

18. The method according to claim 17, wherein the covering film is a single continuous, clear, transparent film.
